(19) United States
(12) Patent Application Publication
(10) Pub. No.: US 2026/0184616 A1
(43) Pub. Date: Jul. 2, 2026

(54) SLUDGE HIGH-DRY DEWATERING DEVICE WITH SYNCHRONOUS ONLINE DETECTION OF PORE SIZE AND MOISTURE CONTENT

(71) Applicant: CHINA JILIANG UNIVERSITY, Hangzhou City (CN)

(72) Inventors: Binqi Rao, Hangzhou City (CN); Wenqing Li, Hangzhou City (CN); Haizhou Cao, Hangzhou City (CN); Taotao Zhao, Hangzhou City (CN); Fang Zhou, Hangzhou City (CN); Yan Zhang, Hangzhou City (CN); Quanfa Zhou, Hangzhou City (CN); Haoke Zhang, Hangzhou City (CN)

(21) Appl. No.: 19/282,279

(22) Filed: Jul. 28, 2025

(30) Foreign Application Priority Data
Dec. 27, 2024 (CN) 202411952491.X

(51) Int. Cl. C02F 11/122; C02F 11/131

(52) U.S. Cl. CPC C02F 11/122; C02F 11/131

(57) ABSTRACT

A high-pressure mechanical dewatering device with multiple filter plates arranged side by side and a centralized control console for controlling the operation of the high-pressure mechanical dewatering device. The high-pressure mechanical dewatering device is equipped with a sludge sampling device, which is electrically connected to the centralized control console and is controlled by the centralized control console to operate the sludge sampling device. It also includes an online moisture content detection device and a pore size detection device. Both the online moisture content detection device and the pore size detection device are electrically connected to the centralized control console.

### CROSS-REFERENCE TO RELATED APPLICATIONS

This application claims priority to Chinese State Intellectual Patent Application Number CN202411952491.X entitled “SLUDGE HIGH-DRY DEWATERING DEVICE WITH SYNCHRONOUS ONLINE DETECTION OF PORE SIZE AND MOISTURE CONTENT” and filed on Dec. 27, 2024 for Bingqi Rao, the entire contents of which are incorporated herein by reference for all purposes.

### FIELD

The subject matter disclosed herein relates generally to a dewatering device, and, more particularly, to an integrated device for highly dry dewatering of sludge capable of simultaneous online detection of pore size and moisture content.

### BACKGROUND INFORMATION

Pressure is used to dewater sludge.

### BRIEF DESCRIPTION

The technical solution of the invention is providing a sludge high-dry dewatering device with synchronous online detection of pore size and moisture content. It includes a high-pressure mechanical dewatering device with multiple filter plates arranged side by side and a centralized control console for controlling the operation of the high-pressure mechanical dewatering device. During dewatering, the centralized control console controls the high-pressure mechanical dewatering device to perform pressure filtration dewatering on the sludge. The feature lies in that the high-pressure mechanical dewatering device is provided with a sludge sampling device, and the sludge sampling device is electrically connected to the centralized control console. The operation of the sludge sampling device is controlled by the centralized control console. It also includes an online moisture content detection device and a pore size detection device, both of which are electrically connected to the centralized control console. After the initial dewatering is completed by the high-pressure mechanical dewatering device, the sludge sampling device takes samples from the sludge after the initial dewatering and sends the samples to the online moisture content detection device and the pore size detection device respectively for testing. The test results are sent to the centralized control console for processing and storage. The centralized control console determines whether the sludge needs further dewatering based on the test results.

The mechanical pressure range of the high-pressure mechanical dewatering device is between 0.1 and 8 megapascals (Mpa) and is adjustable. The centralized control console determines whether the pore size and moisture content of the sludge need further filtration and re-drying based on the information fed back by the online moisture content detection device and the pore size detection device, and adjusts the size of the mechanical filtration and the power and frequency of the microwave drying respectively.

It also includes a microwave drying device set up in the high-pressure mechanical dewatering device. During the pressure filtration dewatering process of the high-pressure mechanical dewatering device, the microwave drying device simultaneously dehydrates the sludge.

The microwave drying device comprises a microwave generator, a microwave control module, a ceramic material plate, a plastic cushion pad and a plastic lining plate; The microwave generator is embedded and fixed in the filter plate. The side wall of the filter plate in the direction of microwave emission of the microwave generator is attached with a ceramic material plate. In the direction away from the filter plate, the ceramic material plate is successively provided with a plastic buffer pad and a plastic backing plate. The plastic buffer pad is attached to the ceramic material plate, and the plastic backing plate is attached to the plastic buffer pad. The microwave generator is electrically connected to the microwave control module set up at the centralized control console. During dewatering, the microwave generator emits high-frequency and high-power microwaves to dry the sludge.

The microwave power and frequency of the microwave generator can be adjusted in magnitude through the microwave control module based on data feedback, achieving precise control of drying energy consumption.

Compared with the existing technology, the present invention with the above structure has the following advantages:
(1) The filter plate is provided with cable holes for cable connection to the microwave generator and the microwave control module.
(2) The top of the filter plate is provided with a mud sampling port, and the sludge sampling device can be extended into the filter plate through the mud sampling.
(3) The screw at the mud mouth is connected with a sealing bolt to seal the mud mouth, and the sealing bolt can be removed by turning the sealing bolt to open the mud mouth.
(4) The sludge sampling device described is a cylindrical sampler that can be inserted between the filter plates for sampling. At the bottom of the cylindrical sampler, there are two opposite jaws that can open or close the opening at the bottom of the cylindrical sampler. Inside the cylindrical sampler, there is a piston that can completely push out the sludge.
(5) The cylindrical sampler is fixed at the movable end of the mechanical arm set o the high-pressure mechanical dewatering device, and the sampling and sample feeding of the cylindrical sampler are controlled by the mechanical arm.

### BRIEF DESCRIPTION OF DRAWINGS

FIG. 1 is a schematic diagram of the structure of the sludge high-dry dewatering device with synchronous online detection of pore size and moisture content.

FIG. 2 is a schematic diagram of the structure of the high-pressure mechanical dewatering device in the sludge high-dry dewatering device with synchronous online detection of pore size and moisture content.

FIG. 3 is a schematic diagram of the structure of the microwave drying device in the sludge high-dry dewatering device with synchronous online detection of pore size and moisture content.

FIG. 4 is a schematic diagram of the structure of the sludge sampling device in the sludge high-dry dewatering device with synchronous online detection of pore size and moisture content.

FIG. 5 is a schematic diagram of the structure of the on-line detection device for moisture content in the sludge high-dry dewatering device with synchronous online detection of pore size and moisture content.

FIG. 6 is a schematic diagram of the structure of the pore size detection device in the sludge high-dry dewatering device with synchronous online detection of pore size and moisture content.

FIG. 7 is the module diagram of the centralized console in the sludge high-dry dewatering device with synchronous online detection of pore size and moisture content.

FIG. 8 is the flow chart of the sludge high-dry dewatering device with synchronous online detection of pore size and moisture content.

### DETAILED DESCRIPTION

Sludge dewatering is an important technology in the environmental field. Its main purpose is to remove the water from the sludge produced during the sewage treatment process, making the sludge denser, easier to handle and dispose of. Effective sludge dewatering can not only reduce the volume of sludge, lower transportation and disposal costs, but also facilitate subsequent resource recovery. Therefore, enhancing the efficiency of sludge dewatering and reducing energy consumption are important directions for current technological development. This technology is also of great significance for environmental protection and sustainable social development.

The sludge dewatering technology in the existing technology usually adopts the filtration effect of the filter press for dewatering work. However, the existing filter press still has the following defects in practical use:
(1) In the process of in situ synergistic dewatering of sludge, the existing technology is not equipped with a sample sampling device to detect the pore size and moisture content of sludge in real time. This defect makes it impossible for operators to obtain information on the changes in sludge characteristics in a timely manner, thereby affecting the optimization of the dewatering effect.
(2) In the cooperative dewatering process of microwave and machinery, the moisture content and porosity of sludge cannot be observed in real time, which leads to the lack of necessary data guidance for the whole dewatering system. The lack of such information affects the accuracy of the operation, thereby reducing the operational precision and dewatering efficiency of the equipment.
(3) At present, the energy consumption of microwave drying technology is relatively high. The main reason is that the pore size and moisture content cannot be monitored in real time, resulting in unreasonable energy distribution and inability to effectively reduce energy consumption. Furthermore, the utilization efficiency of thermal energy has not been fully exerted, further affecting the dewatering efficiency.

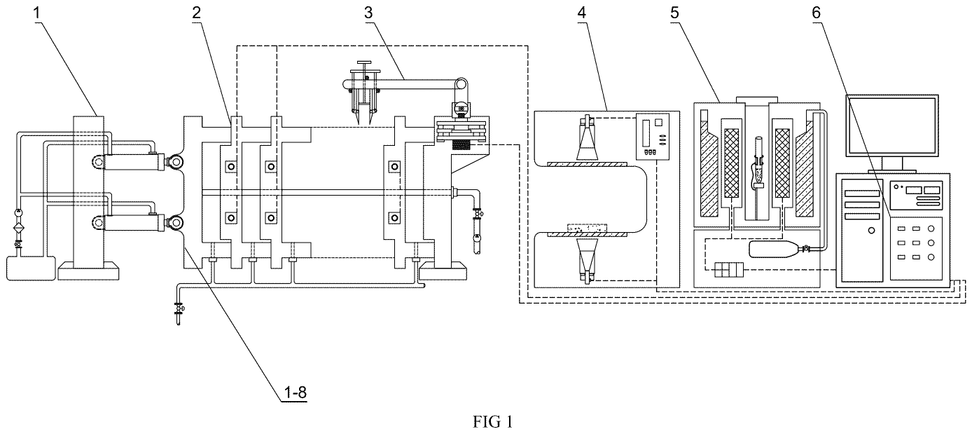

FIG. 1 is a schematic diagram of the structure of the sludge high-dry dewatering device with synchronous online detection of pore size and moisture content. The device comprises a high-pressure mechanical dewatering device 1 with multiple filter plates 1-8 arranged side by side and a centralized control console 6 for controlling the operation of the high-pressure mechanical dewatering device 1. During dewatering, the centralized control console 6 controls the high-pressure mechanical dewatering device 1 to perform pressure filtration dewatering on the sludge. The high-pressure mechanical dewatering device 1 is provided with a sludge sampling device 3. The sludge sampling device 3 is electrically connected to the centralized console 6, and the operation of the sludge sampling device 3 is controlled by the centralized console 6. It also includes the online moisture content detection device 4 and the pore size detection device 5, both of which are electrically connected to the centralized control console 6. After the initial dewatering is completed in the high-pressure mechanical dewatering device 1, the sludge sampling device 3 takes samples from the sludge after the initial dewatering and sends the samples to the online moisture content detection device 4 and the pore size detection device 5 respectively for testing. The test results are sent to the centralized control console 6 for processing and storage. The centralized console 6 determines whether the sludge needs further dewatering based on the test results.

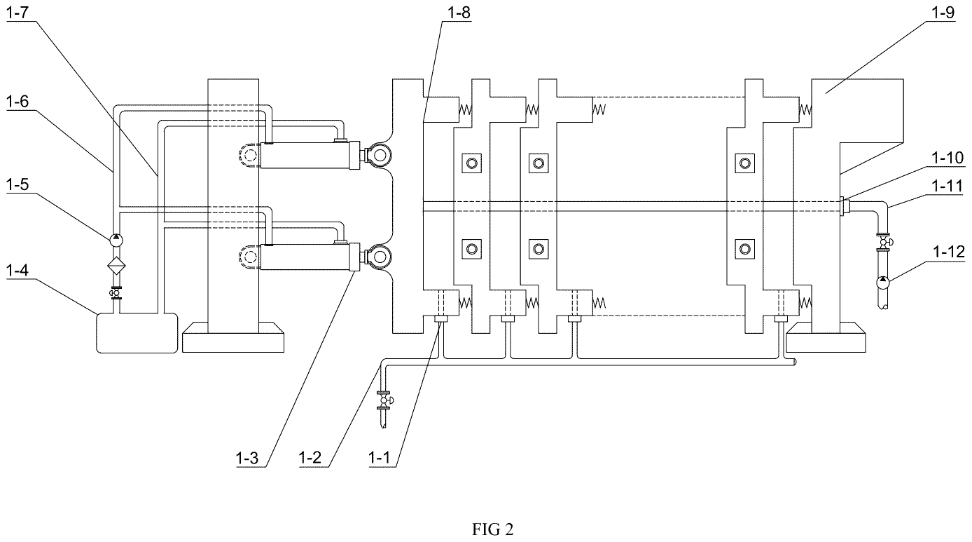

FIG. 2 is a schematic diagram of the structure of the high-pressure mechanical dewatering device in the sludge high-dry dewatering device with synchronous online detection of pore size and moisture content. The high-pressure mechanical dewatering device 1 comprises a drainage hole 1-1, a drainage pipe 1-2, a hydraulic cylinder 1-3, a hydraulic oil tank 1-4, a high-pressure oil pump 1-5, an oil inlet pipe 1-6, a return oil pipe 1-7, a filter plate 1-8, a filter press tail plate 1-9, a mud inlet 1-10, a sludge inlet pipe 1-11 and a sludge inlet pump 1-12. The mud inlet 1-10 of the sludge inlet pipes 1-11 are equipped with sludge inlet pumps 1-12. When the sludge inlet pumps 1-12 start, the sludge is sent into the filter press chamber through the mud inlet 1-10 and the sludge inlet pipes 1-11. The high-pressure oil pump 1-5 is connected to the filter press head plate of the high-pressure mechanical dewatering device 1. The filter press tail plates 1-9 of the high-pressure mechanical dewatering device 1 are connected to the sludge inlet pipes 1-11. When the filtration work begins, the high-pressure oil pump 1-5 starts to provide thrust to the first filter press plate. Then, the first filter press plate slowly pushes each filter press plate 1-8 to approach the filter press tail plates 1-9 to form a closed cavity for high-pressure filtration of the sludge. The lower end of the high-pressure mechanical dewatering device 1 is provided with a filtrate drainage pipe 1-2. The drainage pipe 1-2 is connected to the drainage hole 1-1 in the high-pressure mechanical dewatering device 1 through a metal hose. The filtered water after the sludge is squeezed by each filter plate 1-8 flows out of the high-pressure mechanical dewatering device 1 through the drainage hole 1-1.

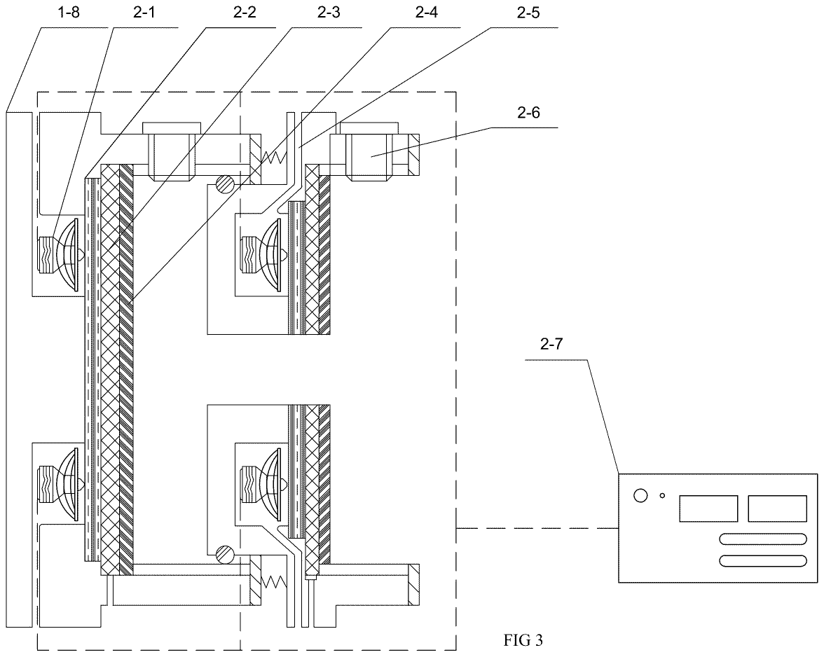

FIG. 3 is a schematic diagram of the structure of the microwave drying device in the sludge high-dry dewatering device with synchronous online detection of pore size and moisture content. The integrated device also includes a microwave drying device 2 set in the high-pressure mechanical dewatering device 1. When the high-pressure mechanical dewatering device 1 is performing filter dewatering, the microwave drying device 2 simultaneously dehydrates the sludge.

The microwave drying device 2 comprises a microwave generator 2-1, a microwave control module 2-7, a ceramic material plate 2-2, a plastic buffer pad 2-3 and a plastic liner plate 2-4. The microwave generator 2-1 is embedded and fixed in the filter plates 1-8. Ceramic material plates 2-2 are attached to the side wall of the filter plates 1-8 in the microwave emission direction of the microwave generator 2-1. Plastic buffer pads 2-3 and plastic backing plates 2-4 are successively provided in the direction away from the filter plates 1-8. The plastic buffer pads 2-3 are attached to the ceramic material plates 2-2. The plastic liner 2-4 is attached to the plastic buffer pad 2-3. The microwave generator 2-1 is electrically connected to the microwave control module 2-7 set at the centralized control console 6. During dewatering, the microwave generator 2-1 emits high-frequency and high-power microwaves to dry the sludge.

The microwave power and frequency of the microwave generator 2-1 can be adjusted in magnitude through the microwave control module 2-7 based on data feedback, achieving precise control of energy consumption in the drying process.

The filter plates 1-8 are provided with cable holes 2-5 for cable connection to the microwave generator 2-1 and the microwave control module 2-7.

The top of the filter plates 1-8 is provided with sludge sampling ports 2-6, and the sludge sampling device 3 can extend into the space between the filter plates 1-8 through the sludge sampling ports 2-6 for sampling.

The mud removal ports 2-6 are threaded with sealing bolts for sealing the mud removal ports 2-6. By turning the sealing bolts, the sealing bolts can be removed to open the mud removal ports 2-6.

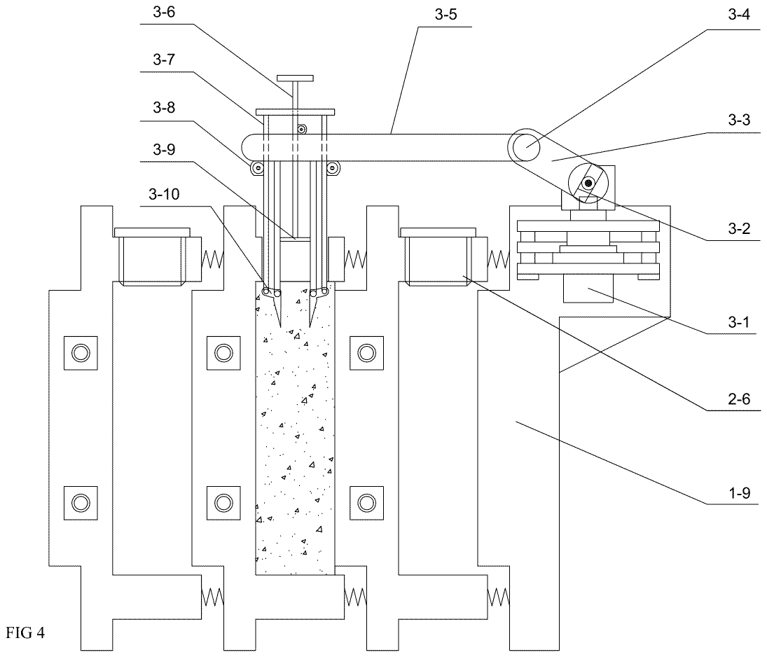

FIG. 4 is a schematic diagram of the structure of the sludge sampling device in the sludge high-dry dewatering device with synchronous online detection of pore size and moisture content. The sludge sampling device 3 is a cylindrical sampler that can be extended between filter plates 1-8 for sampling. At the bottom of the cylindrical sampler, there are two opposite jaws 3-10 that can open or close the opening at the bottom of the cylindrical sampler. Inside the cylindrical sampler, there is a piston 3-9 that can completely push out the sludge.

The cylindrical sampler is fixed at the movable end of the mechanical arm set on the high-pressure mechanical dewatering device 1, and the sampling and sample feeding of the cylindrical sampler are controlled by the mechanical arm.

Specifically, the sludge automatic sampling device 3 comprises a first drive motor 3-1, a second drive motor 3-2, a large connecting rod 3-3, a third drive motor 3-4, a small connecting rod 3-5, a piston rod 3-6, a claw drive rod 3-7, a fourth drive motor 3-8, a piston 3-9 and a claw 3-10. The sludge sampling device 3 is fixed on the high-pressure mechanical dewatering device 1. When taking sludge samples, the bolts of the sludge sampling port 2-6 above the filter press chamber are unscrewed. The sludge sampling device 3 can rotate 360°through the first drive motor 3-1, and the second drive motor 3-2 provides power to drive the large connecting rod 3-3. The large connecting rod 3-3 is connected to the small connecting rod 3-5 through the third drive motor 3-4 and rotates up and down. The claw drive rod 3-7, under the action of the fourth drive motor 3-8, controls the claw 3-10 to extend into the filter press chamber through the sludge taking port 2-6 to take a complete sample of the sludge after filtration and microwave drying. The piston 3-9 is connected through the piston rod 3-6. When placing sludge samples, it acts as a thrust to ensure the integrity of the sludge structure, facilitate the detection of small pore diameters in the sludge, and improve the accuracy. Among them, the first drive motor 3-1, the second drive motor 3-2, the large connecting rod 3-3, the third drive motor 3-4, the small connecting rod 3-5 and the gripper 3-10 constitute the mechanical arm as a whole.

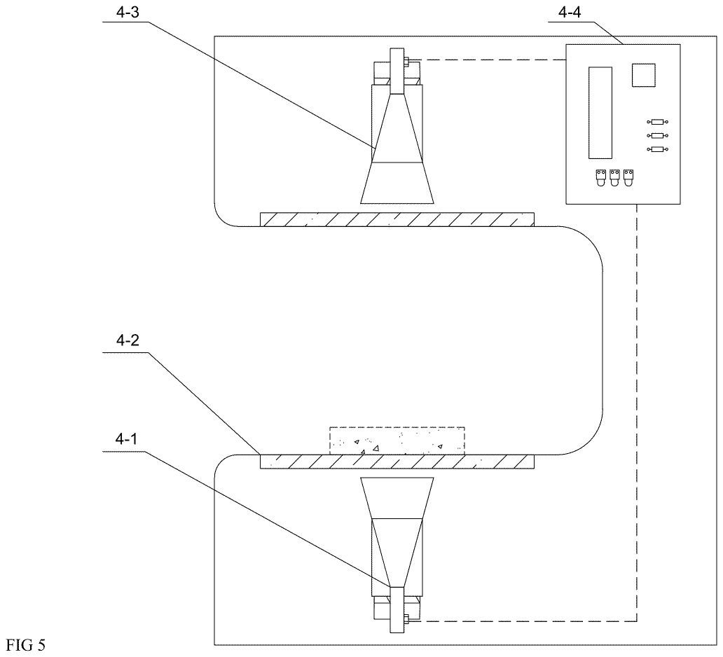

FIG. 5 is a schematic diagram of the structure of the online detection device for moisture content in the sludge high-dry dewatering device with synchronous online detection of pore size and moisture content. The online moisture content detection device 4 mentioned includes a microwave receiver 4-1, a microwave transmitting antenna 4-3, a microwave sensor 4-4 and a ceramic plate 4-2. When the moisture content online detection device 4 needs to test the moisture content of the sludge, the sludge sampling device 3 sends the sludge sample to the ceramic plate 4-2. The microwave transmitting antenna 4-3 connected to the microwave sensor 4-4 emits a low-frequency microwave signal (with a frequency of 2.45 GHz), which is received by the microwave receiver 4-1 through the sludge sample. And it is transmitted to microwave sensor 4-4. Microwave sensor 4-4 converts the received signal and calculates the moisture content of the sludge sample through the model. The data acquisition system stores the moisture content data and sends it to the feedback control system.

Further, the online moisture content detection device 4 uses the microwave transmission method for online moisture content detection; Basic principle: Microwave is a high-frequency electromagnetic wave with wave-particle duality. When its microwaves are irradiated onto non-metallic substances, they can penetrate the interior of the substances and undergo attenuation. Among them, microwave attenuation is related to the dielectric constant, and the dielectric constant is related to the moisture content. Thus, it can be concluded that there is a correlation between microwave attenuation and moisture content. The measurement formula was obtained by fitting the microwave attenuation of microwaves passing through sludge with the moisture content of sludge, and then the moisture content of sludge was calculated.

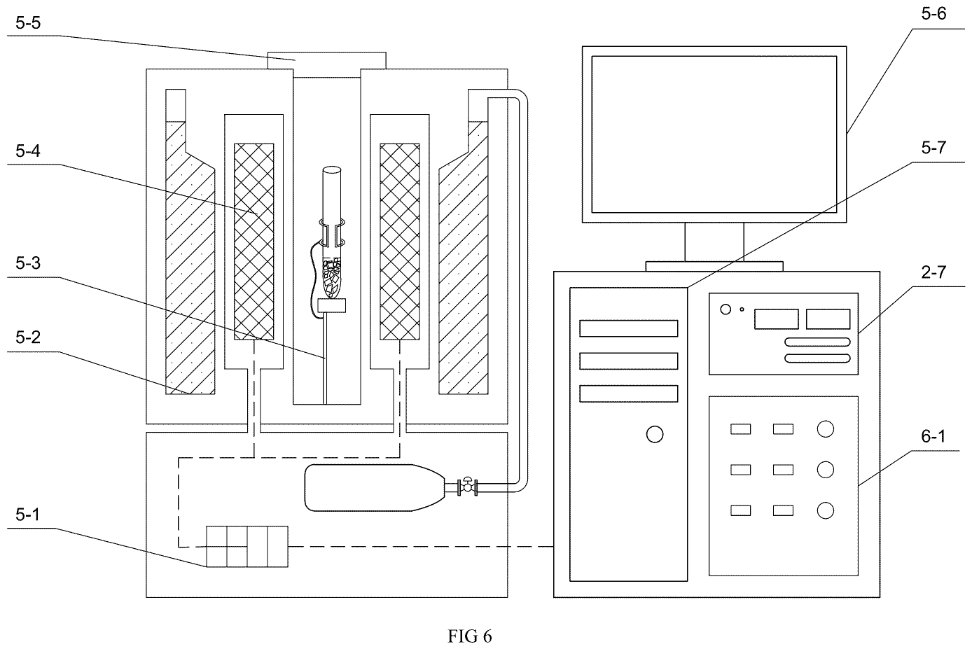

FIG. 6 is a schematic diagram of the structure of the pore size detection device in the sludge high-dry dewatering device with synchronous online detection of pore size and moisture content. The pore size detection device 5 is a low-field nuclear magnetic resonance pore size detection equipment, including a tuned radio frequency circuit 5-1, a vacuum chamber 5-2, a radio frequency tube 5-3, liquid nitrogen 5-4, an anti-pollution cover 5-5, a user interface 5-6, a data acquisition and processing system 5-7, and a feedback control system 6-1. The pore size detection device 5 adopts the online detection technology of nuclear magnetic resonance material structure to conduct online detection of the pore size of sludge. Basic principle: By using the nuclear magnetic resonance phenomenon to measure the relaxation time of water molecules in sludge, the pore size distribution of sludge can be inferred. The H protons in the sample are detected by the low-field nuclear magnetic resonance equipment. After the sample is placed in the magnetic field, the H protons resonate by emitting radio frequency pulses of a certain frequency. After absorbing the energy of the radio frequency pulses, the H protons are released. The process of these energy releases is detected by the coil, thereby obtaining the nuclear magnetic resonance signal. The relaxation times of water molecules in sludge with different pore sizes are different. By analyzing these signals, the pore size of the sludge can be inferred.

It should be noted that the above-mentioned mechanical arm, the online moisture content detection device 4 and the pore size detection device 5 can all adopt mature equipment in the existing technology. The connection methods of the specific internal structures can be obtained by technicians in the field based on common knowledge, and will not be elaborated here.

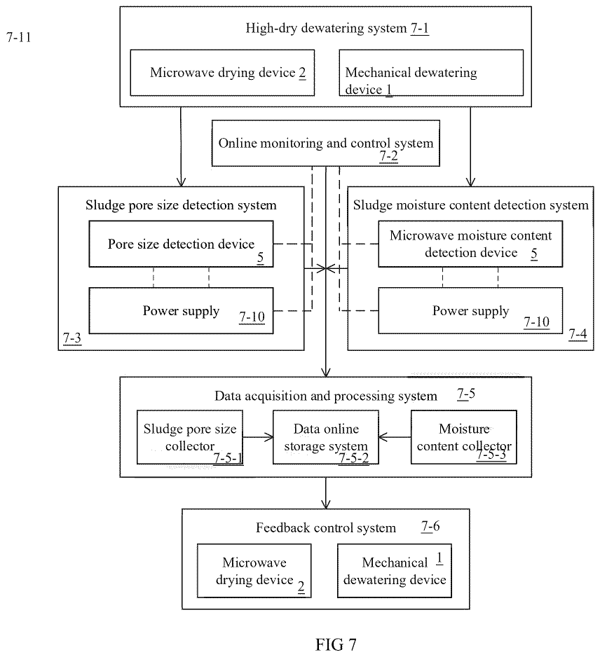

FIG. 7 is the module diagram of the centralized console 7-11 in the sludge high-dry dewatering device with synchronous online detection of pore size and moisture content. The integrated device includes a high-dryness dewatering system 7-1, an online detection and control system 7-2, a sludge pore size detection system 7-3, a sludge moisture content detection system 7-4, a data acquisition and processing system 7-5, a feedback control system 7-6. The console 7-11 further includes a user interface, a microwave control module, a power supply 7-10 and an online network. The data acquisition and processing system 7-5 may comprise a sludge pore size collector 7-5-1, a data online storage system 7-5-2, and a moisture content collector 7-5-3. The microwave control module is used to control the microwave power and frequency of the microwave drying device 2. The described high-dryness sludge dewatering system consists of a microwave drying device 2 and a high-pressure mechanical dewatering device 1, which are used for mechanical filtration and drying of sludge. The online monitoring and control system 7-2 consists of an online moisture content detection device 4 and a pore size detection device 5, which are used to measure the moisture content and pore size data of sludge during the mechanical filtration and drying processes. The measured data is transmitted to the online network data through the data acquisition and processing system and sent to the feedback control system. Staff can view the data information of pore size and moisture content in real time through the user interface. The feedback control system in the centralized control console is connected to the high-pressure mechanical dewatering device 1, the automatic sludge sampling device 3, the microwave drying device 2, the online moisture content detection device 4 and the pore size detection device 5 through control lines. It determines whether the pore size is within the range of 1-10 micrometers (μm) and whether the moisture content is below 40% based on the detected data information. Then, online feedback control is carried out on the working equipment until the sludge dewatering and drying results meet the pore size within the range of 1-10 μm and the moisture content is below 40%.

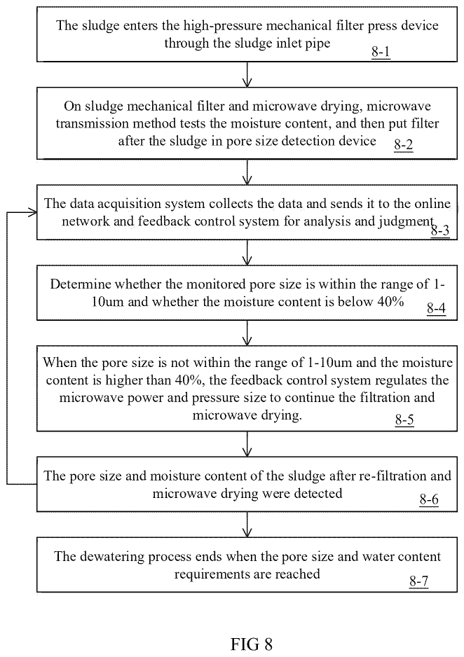

FIG. 8 is the flow chart of the sludge high-dry dewatering device with synchronous online detection of pore size and moisture content. The working process of this system is as follows: Before the device starts to work and feed sludge, the high-pressure mechanical dewatering device 1 is in the dehumidification state; The sludge inlet pumps 1-12 work to make the sludge enter 8-1 the high-pressure mechanical dewatering device 1 through the sludge inlet pipes 1-11. The mechanical pressure range is between 0.1 and 8 Mpa and is adjustable. The high-pressure oil pump 1-5 pushes the filter plates 1-8 to perform the filtration operation on the sludge. The microwave drying device 2 performs microwave drying on the sludge. After the first filtration and drying operations are completed, the sludge sampling device 3 quickly takes 8-2 samples of the sludge. The moisture content and pore size are detected through the online moisture content detection device 4 and the pore size detection device 5. The data acquisition and processing system collects 8-3, stores and sends 8-3 the detected data to the feedback control system to determine 8-4 whether the pore size and moisture content of the sludge need further filtration and re-drying. And through the feedback control system and microwave control module in the centralized control console 6 of the device, the size of the mechanical filter press and the power and frequency of microwave drying are respectively adjusted to make the dewatering process more accurate, the dewatering efficiency better, and make full use of energy to reduce energy consumption; When 8-5 the monitored pore size is within the range of 1-10 μm and the moisture content is below 40%, the dewatering effect is achieved and the dewatering process is completed. When the situation does not meet the above standards, proceed to the next step of mechanical filtration and microwave drying operations to further reduce the moisture content and pore size of the sludge. Then repeat the above detection 8-6 and judgment operations. If the standards are met, the dewatering process is completed 8-7; otherwise, continue with mechanical filtration and microwave drying until the set standards are reached to end the work.

Although the present invention has been described in detail with reference to the aforementioned embodiments, for those skilled in the art, it is still possible to modify the technical solutions recorded in the aforementioned embodiments or make equivalent substitutions for some of the technical features therein. Any modifications, equivalent substitutions, improvements, etc. made within the spirit and principles of the present invention, all should be included within the protection scope of the present invention, and the contents not described in detail in this specification all belong to the prior art known to those skilled in the art.

1. A device comprising:
a high-pressure mechanical dewatering device with multiple filter plates arranged side by side;
an integrated console for controlling operation of the high-pressure mechanical dewatering device;
a sludge sampling device that samples sludge in real time and comprises is a tubular sampler extendable into the filter plates for sampling, and a bottom of the tubular sampler is provided with two opposite claws configured to open or close an opening at the bottom of the tubular sampler, the tubular sampler is equipped with a piston configured to completely push out the sludge, the tubular sampler is fixed on a movable end of a mechanical arm arranged on the high-pressure mechanical dewatering device, and the mechanical arm controls sampling and sample delivery of the tubular sampler, wherein the sludge sampling device is electrically connected to the integrated console, and operation of the sludge sampling device is controlled by the integrated console;
an online moisture content detection device electrically connected to the integrated console;
a pore size detection device electrically connected to the integrated console; and
a microwave drying device set up in the high-pressure mechanical dewatering device; wherein, during a dewatering process, the high-pressure mechanical dewatering device is controlled by the integrated console to perform pressure filtration dewatering on sludge;
wherein the microwave drying device simultaneously dehydrates the sludge during the pressure filtration dewatering process;
wherein, after initial dewatering is completed by the high-pressure mechanical dewatering device, the sludge sampling device takes samples from the sludge after the initial dewatering and sends the samples to the online moisture content detection device and the pore size detection device respectively for testing;
wherein test results from the online moisture content detection device and the pore size detection device are sent to the integrated console for processing and storage;
wherein the integrated console determines whether the sludge needs further dewatering based on the test results;
wherein a mechanical pressure range of the high-pressure mechanical dewatering device is between 0.1 and 8 megapascals (Mpa) and is adjustable;
wherein the integrated console determines whether pore size and moisture content of the sludge need further filtration and re-drying based on information fed back by the online moisture content detection device and the pore size detection device, and adjusts size of mechanical filtration and power and frequency of microwave drying respectively;
wherein the microwave drying device comprises a microwave generator, a microwave control module, a ceramic material plate, a plastic buffer pad, and a plastic lining plate;
wherein the microwave generator is embedded and fixed in a filter plate;
wherein a side wall of the filter plate in a direction of microwave emission of the microwave generator is attached with the ceramic material plate;
wherein, in a direction away from the filter plate, the ceramic material plate is successively provided with the plastic buffer pad and the plastic backing plate;
wherein the plastic buffer pad is attached to the ceramic material plate, and the plastic backing plate is attached to the plastic buffer pad; and
wherein the microwave generator is electrically connected to the microwave control module set up at the integrated console, and microwave power and frequency of the microwave generator can be adjusted in magnitude through the microwave control module based on data feedback.

2. The device of claim 1, wherein the filter plate is provided with a cable hole for connecting a cable to the microwave generator and the microwave control module.

3. The device of claim 1, wherein a top of the filter plate is provided with a sludge sampling port, and the sludge sampling device is extendable into the filter plate for sampling through the sludge sampling port.

4. The device of claim 3, wherein a thread at the sludge sampling port is connected with a sealing bolt that seals the sludge sampling port, and the sealing bolt is removable by turning the sealing bolt to open the sludge sampling port.

5. The device of claim 1, wherein the online moisture content detection device includes a microwave receiver, a microwave transmitting antenna, a microwave sensor, and a ceramic plate, and is configured to detect moisture content using a microwave transmission method.

6. The device of claim 1, wherein the pore size detection device is a low-field nuclear magnetic resonance pore size detection equipment configured to measure relaxation time of water molecules in sludge to infer pore size distribution.

7. The device of claim 1, wherein the integrated console determines that the dewatering process is completed when pore size of the sludge is within a range of 1-10 micrometers (μm) and moisture content is below 40%.
